(19) United States
(12) Patent Application Publication
(10) Pub. No.: US 2005/0001738 A1
(43) Pub. Date: Jan. 6, 2005

(54) Transmission element for downhole drilling components

(76) Inventors: David R. Hall, Provo, UT (US); Joe Fox, Provo, UT (US)

Correspondence Address: GRANT PRIDECO, L.P.;JEFFREY E. DALY, 400 N. Sam Houston Parkway, Suite 900, HOUSTON, TX, 77060, US

(21) Appl. No.: 10/612,255

(22) Filed: Jul. 2, 2003

(51) Int. Cl. G01V 3/00; H04H 9/00

(52) U.S. Cl. 340/854.8; 367/81

(57) ABSTRACT

An apparatus for transmitting data between downhole tools is disclosed in one embodiment of the present invention as including an annular core constructed of a magnetically-conductive material. At least one conductor, electrically isolated from the annular core, is coiled around the annular core. An annular housing constructed of an electrically conductive material is used to partially enclose the annular core and the conductive coil. The annular housing is shaped to reside within an annular recess formed into a surface of a downhole tool, and is electrically insulated from the surface. A biasing member is used to effect a bias between the annular housing and the annular recess, urging the annular housing in a direction substantially perpendicular to the surface.

### 1. RELATED APPLICATIONS

This application is a continuation-in-part of U.S. patent application Ser. No. ______(INSERT NUMBER) entitled IMPROVED TRANSDUCER FOR DOWNHOLE DRILLING COMPONENTS filed on ______(INSERT DATA).

### BACKGROUND OF THE INVENTION

1. The Field of the Invention

This invention relates to oil and gas drilling, and more particularly to apparatus and methods for reliably transmitting information to the surface from downhole drilling components.

2. The Relevant Art

For several decades, engineers have worked to develop apparatus and methods to effectively transmit information from components located downhole on oil and gas drilling strings to the ground's surface. Part of the difficulty lies in the development of reliable apparatus and methods for transmitting information from one drill string component to another, such as between sections of drill pipe. The goal is to provide reliable information transmission between downhole components stretching thousands of feet beneath the earth's surface, while withstanding hostile wear and tear of subterranean conditions.

In an effort to provide solutions to this problem, engineers have developed a technology known as mud pulse telemetry. Rather than using electrical connections, mud pulse telemetry transmits information in the form of pressure pulses through fluids circulating through a well bore. However, data rates of mud pulse telemetry are very slow compared to data bandwidths needed to provide real-time data from downhole components.

For example, mud pulse telemetry systems often operate at data rates less than 10 bits per second. At this rate, data resolution is so poor that a driller is unable to make crucial decisions in real time. Since drilling equipment is often rented and very expensive, even slight mistakes incur substantial expense. Part of the expense can be attributed to time-consuming operations that are required to retrieve downhole data or to verify low-resolution data transmitted to the surface by mud pulse telemetry. Often, drilling or other procedures are halted while crucial data is gathered.

In an effort to overcome limitations imposed by mud pulse telemetry systems, reliable connections are needed to transmit information between components in a drill string. For example, since direct electrical connections between drill string components may be impractical and unreliable, other methods are needed to bridge the gap between drill string components.

Various factors or problems may make data transmission unreliable. For example, dirt, rocks, mud, fluids, or other substances present when drilling may interfere with signals transmitted between components in a drill string. In other instances, gaps present between mating surfaces of drill string components may adversely affect the transmission of data therebetween.

Moreover, the harsh working environment of drill string components may cause damage to data transmission elements. Furthermore, since many drill string components are located beneath the surface of the ground, replacing or servicing data transmission components may be costly, impractical, or impossible. Thus, robust and environmentally-hardened data transmission components are needed to transmit information between drill string components.

### SUMMARY OF THE INVENTION

In view of the foregoing, it is a primary object of the present invention to provide robust transmission elements for transmitting information between downhole tools, such as sections of drill pipe, in the presence of hostile environmental conditions, such as heat, dirt, rocks, mud, fluids, lubricants, and the like. It is a further object of the invention to maintain reliable connectivity between transmission elements to provide an uninterrupted flow of information between drill string components.

Consistent with the foregoing objects, and in accordance with the invention as embodied and broadly described herein, an apparatus for transmitting data between downhole tools is disclosed in one embodiment of the present invention as including an annular core constructed of a magnetically-conductive material. At least one conductor, electrically isolated from the annular core, is coiled around the annular core. An annular housing constructed of an electrically conductive material is used to partially enclose the annular core and the conductive coil. The annular housing is shaped to reside within an annular recess formed into a surface of a downhole tool, and is electrically insulated from the surface. A biasing member is used to cause a bias between the annular housing and the annular recess, urging the annular housing in a direction substantially perpendicular to the surface.

In selected embodiments, a retention mechanism may be provided to retain the annular housing within the annular recess. In addition, the biasing member may be a metal spring, an elastomeric material, or an elastomeric-like material.

In certain embodiments, the annular core may be characterized by an elongated cross-section. The annular core may have a cross-section characterized by a height at least twice that of its width.

In another aspect of the invention, a transmission element for transmitting information between downhole tools is disclosed in one embodiment of the present invention as including an annular core constructed of a magnetically conductive material. At least one conductor, electrically isolated from the annular core, is coiled around the annular core. An annular housing constructed of an electrically conductive material is used to partially enclose the annular core and the conductive coil. The annular housing is shaped to reside within an annular recess formed into a surface of a downhole tool, and is electrically insulated from the surface. Means for effecting a bias between the annular housing and the annular recess is provided.

In selected embodiments, means for effecting a bias between the annular housing and the annular recess is provided by radial tension between surfaces of the annular housing and the annular recess. This tension may be due to tension along the outside diameters, the inside diameters, or a combination thereof, of the annular housing and the annular recess.

In another aspect of the present invention, an apparatus for transmitting information between downhole tools located on a drill string includes a transmission element, having a contact, mounted to the end of a downhole tool. Another transmission element, having another contact, is mounted to the end of another downhole tool connectable to the first downhole tool. These contacts are configured to physically contact one another upon connecting the first and second downhole tools. An isolation mechanism is provided to isolate the contacts from their surrounding environment when they come into contact with one another.

### BRIEF DESCRIPTION OF THE DRAWINGS

The foregoing and other features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a perspective view illustrating one embodiment of transmission elements installed in the box and pin ends of drill pipe sections to transmit and receive information along a drill string;

FIG. 2 is a perspective view illustrating one embodiment of the interconnection and interaction between transmission elements;

FIG. 3 is a perspective cross-sectional view illustrating various features of one embodiment of an improved transmission element in accordance with the invention;

FIG. 4 is a perspective cross-sectional view illustrating one embodiment of a multi-coil or multi-strand conductor within a transmission element, and various locking shoulders used to retain the MCEI segments within the annular housing;

FIG. 5 is a perspective cross-sectional view illustrating one embodiment of a single conductor or coil used within the transmission element;

FIG. 6 is a perspective cross-sectional view illustrating one embodiment of a single conductor or coil surrounded by an electrically insulating material used within the transmission element;

FIG. 7 is a perspective cross-sectional view illustrating another embodiment of a transmission element having a flat or planar area formed on the conductor in accordance with the invention;

FIG. 8 is a perspective cross-sectional view illustrating one embodiment of a transmission element having various biasing members to urge components of the transmission element into desired positions;

FIG. 9 is a perspective cross-sectional view illustrating one embodiment of a transmission element having a shelf or ledge formed in the annular housing to accurately position the transmission element with respect to a substrate;

FIG. 10 is a perspective cross-sectional view illustrating one embodiment of a transmission element having an elastomeric or elastomeric-like material to urge the components of the transmission element into desired positions;

FIG. 11 is a perspective cross-sectional view illustrating on embodiment of an annular housing capable of retaining MCEI segments in substantially fixed positions within the annular housing;

FIG. 12 is a perspective view illustrating on embodiment of a transmission element having an electrical conductor coiled around an annular magnetically conductive core;

FIG. 13 is a perspective cross-sectional view illustrating one embodiment of the transmission element of FIG. 12 installed into an annular recess provided in the pin end of a downhole tool;

FIG. 14 is a cross-sectional view illustrating one embodiment of two transmission elements coupled together for signal transmission therebetween;

FIG. 15 is a cross-sectional view illustrating one embodiment of a transmission element having an annular conductive housing layered with an insulating material;

FIG. 16 is a cross-sectional view illustrating one embodiment of an elongated transmission element;

FIG. 17 is a cross-sectional view illustrating one alternative embodiment to the transmission element illustrated in FIG. 16;

FIG. 18 is a cross-sectional view illustrating one embodiment of a transmission element retained by locking shoulders formed into the transmission element and a substrate;

FIG. 19 is a cross-sectional view illustrating one embodiment of two transmission elements installed into the pin end and box end of respective downhole tools;

FIG. 20 is a cross-sectional view illustrating one embodiment of two transmission elements in the pin end and box end of two downhole tools connected together;

FIG. 21 is a cross-sectional view illustrating one embodiment of transmission elements installed into longitudinal surfaces of connected downhole tools;

FIG. 22 is a cross-sectional view illustrating one embodiment of a biased or spring-loaded transmission element having electrical contacts and means for isolating the contacts from the surrounding environment;

FIG. 23 is a cross-sectional view illustrating another embodiment of transmission elements having electrical contacts residing in recesses located on longitudinal surfaces of connected downhole tools;

FIG. 24 is a perspective cross-sectional view illustrating one embodiment of a transmission element having an annular electrical contact;

FIGS. 25A-C are cross-sectional views illustrating various positions of one embodiment of a transmission element having electrical contacts and means for isolating the contacts;

FIGS. 26A-C are cross-sectional views illustrating various positions of another embodiment of a transmission element having electrical contacts and means for isolating the contacts; and

FIG. 27 is a cross-sectional view illustrating one embodiment of a self-cleaning contact that may be used for reliable electrical connections.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of embodiments of apparatus and methods of the present invention, as represented in the Figures, is not intended to limit the scope of the invention, as claimed, but is merely representative of various selected embodiments of the invention.

The illustrated embodiments of the invention will be best understood by reference to the drawings, wherein like parts are designated by like numerals throughout. Those of ordinary skill in the art will, of course, appreciate that various modifications to the apparatus and methods described herein may easily be made without departing from the essential characteristics of the invention, as described in connection with the Figures. Thus, the following description of the Figures is intended only by way of example, and simply illustrates certain selected embodiments consistent with the invention as claimed herein.

In an effort to overcome limitations imposed by mud pulse telemetry systems, reliable connections are needed to transmit information between components in a drill string. For example, since direct electrical connections between drill string components may be impractical and unreliable due to dirt, mud, rocks, air gaps, and the like between components, converting electrical signals to magnetic fields for later conversion back to electrical signals is suggested for transmitting information between drill string components.

Like a transformer, current traveling through a first conductive coil, located on a first drill string component, may be converted to a magnetic field. The magnetic field may then be detected by a second conductive coil located on a second drill string component where it may be converted back into an electrical signal mirroring the first electrical signal. A core material, such as a ferrite, may be used to channel magnetic fields in a desired direction to prevent power loss. However, past attempts to use this “transformer” approach have been largely unsuccessful due to a number of reasons.

For example, power loss may be a significant problem. Due to the nature of the problem, signals must be transmitted from one pipe section, or downhole tool, to another. Thus, air or other gaps are present between the core material of transmission elements. This may incur significant energy loss, since the permeability of ferrite, and other similar materials, may be far greater than air, lubricants, pipe sealants, or other materials. Thus, apparatus and methods are needed to minimize power loss in order to effectively transmit and receive data.

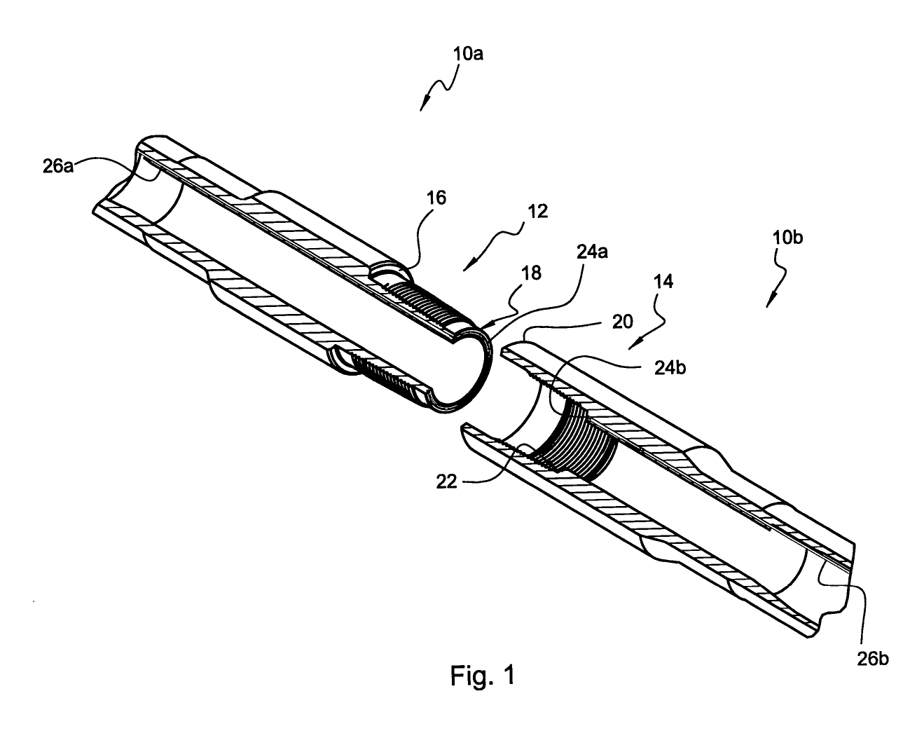

Referring to FIG. 1, drill pipes 10a, 10b, or other downhole tools 10a, 10b, may include a pin end 12 and a box end 14 to connect drill pipes 10a, 10b or other components 10a, 10b together. In certain embodiments, a pin end 12 may include an external threaded portion to engage an internal threaded portion of the box end 14. When threading a pin end 12 into a corresponding box end 14, various shoulders may engage one another to provide structural support to components connected in a drill string.

For example, a pin end 12 may include a primary shoulder 16 and a secondary shoulder 18. Likewise, the box end 14 may include a corresponding primary shoulder 20 and secondary shoulder 22. A primary shoulder 16, 20 may be labeled as such to indicate that a primary shoulder 16, 20 provides the majority of the structural support to a drill pipe 10 or downhole component 10. Nevertheless, a secondary shoulder 18 may also engage a corresponding secondary shoulder 22 in the box end 14, providing additional support or strength to drill pipes 10 or components 10 connected in series.

As was previously discussed, apparatus and methods are needed to transmit information along a string of connected drill pipes 10 or other components 10. As such, one major issue is the transmission of information across joints where a pin end 12 connects to a box end 14. In selected embodiments, a transmission element 24a may be mounted proximate a mating surface 18 or shoulder 18 on a pin end 12 to communicate information to another transmission element 24b located on a mating surface 22 or shoulder 22 of the box end 14. Cables 26a, 26b, or other transmission media 26, may be operably connected to the transmission elements 24a, 24b to transmit information therefrom along components 10a, 10b.

In certain embodiments, an annular recess may be provided in the secondary shoulder 18 of the pin end 12 and in the secondary shoulder 22 of the box end 14 to house each of the transmission elements 24a, 24b. The transmission elements 24a, 24b may have an annular shape and be mounted around the radius of the drill pipe 10. Since a secondary shoulder 18 may contact or come very close to a secondary shoulder 22 of a box end 14, a transmission element 24a may sit substantially flush with a secondary shoulder 18 on a pin end 12. Likewise, a transmission element 24b may sit substantially flush with a surface of a secondary shoulder 22 of a box end 14.

In selected embodiments, a transmission element 24a may be coupled to a corresponding transmission element 24b by having direct electrical contact therewith. In other embodiments, the transmission element 24a may convert an electrical signal to a magnetic field or magnetic current. A corresponding transmission element 24b, located proximate the transmission element 24a, may detect the magnetic field or current. The magnetic field may induce an electrical current into the transmission element 24b. This electrical current may then be transmitted from the transmission element 24b by way of an electrical cable 26b along the drill pipe 10 or downhole component 10.

As was previously stated, a downhole drilling environment may adversely affect communication between transmission elements 24a, 24b located on successive drill string components 10. Materials such as dirt, mud, rocks, lubricants, or other fluids, may inadvertently interfere with the contact or coupling between transmission elements 24a, 24b. In other embodiments, gaps present between a secondary shoulder 18 on a pin end 12 and a secondary shoulder 22 on a box end 14, due to variations in component tolerances, may interfere with communication between transmission elements 24a, 24b. Thus, apparatus and methods are needed to reliably overcome these as well as other obstacles.

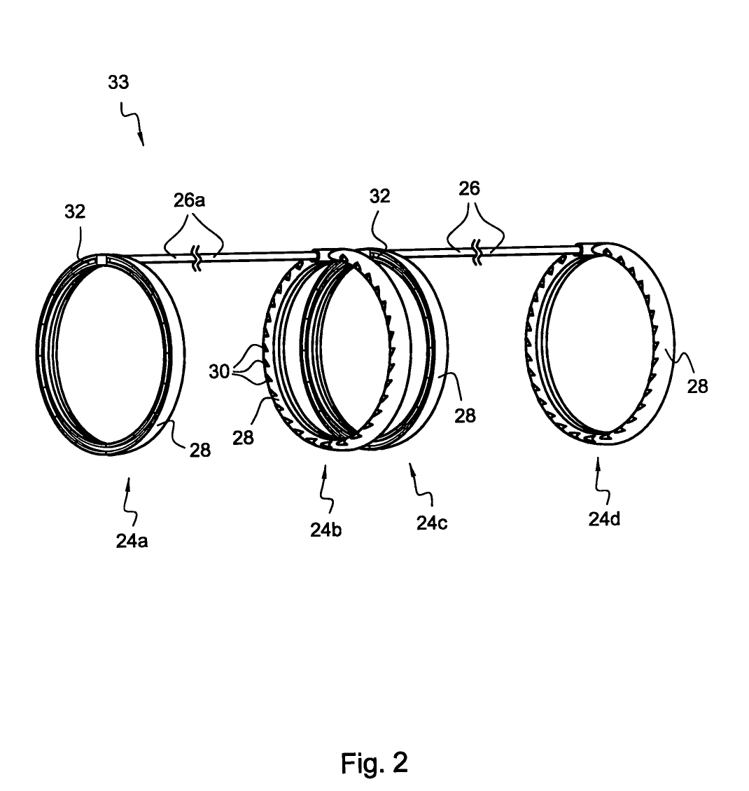

Referring to FIG. 2, in selected embodiments, a transmission element assembly 33 may include a first transmission element 24a mounted in the pin end 12 of a drill pipe 10 or other tool 10, and a second transmission element 24b mounted in the box end 14 of a drill pipe 10 or other tool 10. Each of these transmission elements 24a, 24b may be operably connected by a cable 26a, such as electrical wires, coaxial cable, optical fiber, or like transmission media. Each of the transmission elements 24 may include an exterior annular housing 28. The annular housing 28 may function to protect and retain components or elements within the transmission element 24. The annular housing 28 may have an exterior surface shaped to conform to a recess milled, formed, or otherwise provided in the pin 12 or box end 14 of a drill pipe 10, or other downhole component 10.

In selected embodiments, the annular housing 28 may be surfaced to reduce or eliminate rotation of the transmission elements 24 within their respective recesses. For example, anti-rotation mechanisms, such as barbs or other surface features formed on the exterior of the annular housing 28 may serve to reduce or eliminate rotation.

As is illustrated in FIG. 2, a transmission element 24b located on a first downhole tool 10 may communicate with a transmission element 24c located on a second downhole tool 10. Electrical current transmitted through a coil 32 in a first transmission element 24b may create a magnetic field circulating around the conductor 32. A second transmission element 24c may be positioned proximate the first transmission element 24b such that the magnetic field is detected by a coil 32 in the transmission element 24c.

In accordance with the laws of electromagnetics, a magnetic field circulated through an electrically conductive loop induces an electrical current in the loop. Thus, an electrical signal transmitted to a first transmission element 24b may be replicated by a second transmission element 24c. Nevertheless, a certain amount of signal loss occurs at the coupling of the transmission element 24b, 24c. For example, signal loss may be caused by air or other gaps present between the transmission elements 24b, 24c, or by the reluctance of selected magnetic materials. Thus, apparatus and methods are needed to reduce, as much as possible, signal loss that occurs between transmission elements 24b, 24c.

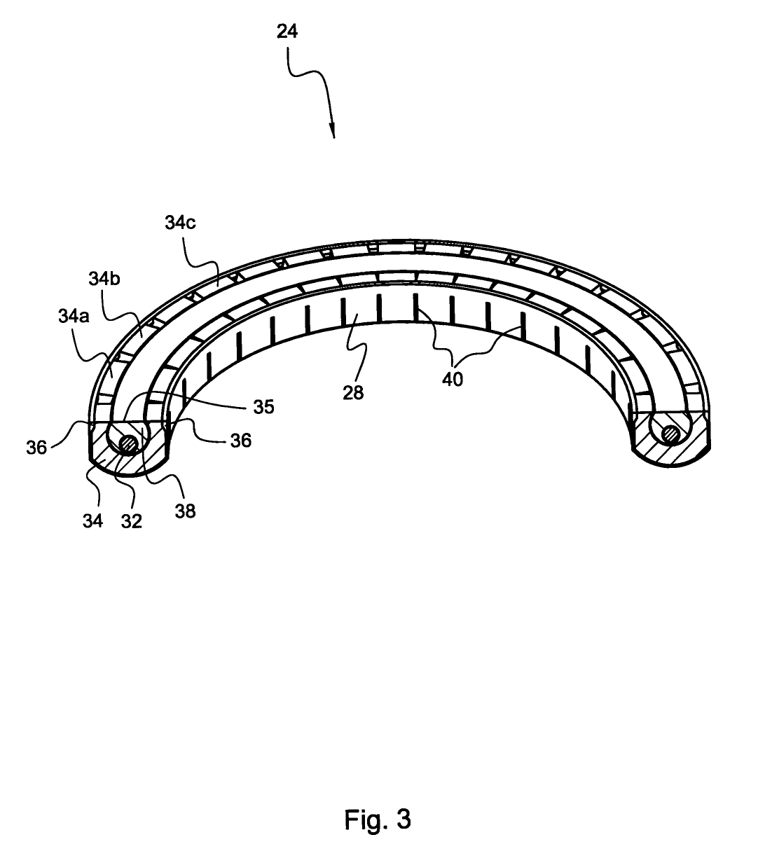

Referring to FIG. 3, a perspective cross-sectional view of one embodiment of a transmission element 24 is illustrated. In selected embodiments, a transmission element 24 may include an annular housing 28, an electrical conductor 32, and a magnetically-conducting, electrically-insulating material 34 separating the conductor 32 from the housing 28.

The MCEI material 34 may prevent electrical shorting between the electrical conductor 32 and the housing 28. In addition, the MCEI material 34 contains and channels magnetic flux emanating from the electrical conductor 32 in a desired direction. In order to prevent signal or power loss, magnetic flux contained by the MCEI material 34 may be directed or channeled to a corresponding transmission element 24 located on a connected downhole tool 10.

The MCEI material 34 may be constructed of any material having suitable magnetically-conductive and electrically-insulating properties. For example, in selected embodiments, certain types of metallic oxide materials such as ferrites, may provide desired characteristics. Ferrites may include many of the characteristics of ceramic materials. Ferrite materials may be mixed, pre-fired, crushed or milled, and shaped or pressed into a hard, typically brittle state. Selected types of ferrite may be more preferable for use in the present invention, since various types operate better at higher frequencies.

Since ferrites or other magnetic materials may be quite brittle, using an MCEI material 34 that is a single piece may be impractical, unreliable, or susceptible to cracking or breaking. Thus, in selected embodiments, the MCEI material 34 may be provided in various segments 34a-c. Using a segmented MCEI material 34a-c may relieve tension that might otherwise exist in a single piece of ferrite. If the segments 34 are positioned sufficiently close to one another within the annular housing 28, signal or power loss between joints or gaps present between the segments 34a-c may be minimized.

The annular housing 28, MCEI material 34, and conductor 32 may be shaped and aligned to provide a relatively flat face 35 for interfacing with another transmission element 24. Nevertheless, a totally flat face 35 is not required. In selected embodiments, a filler material 38 or insulator 38 may be used to fill gaps or volume present between the conductor 32 and the MCEI material 34. In addition, the filler material 38 may be used to retain the MCEI segments 34a-c, the conductor 32, or other components within the annular housing 28.

In selected embodiments, the filler material 38 may be any suitable polymer material such as Halar, or materials such as silicone, epoxies, and the like. The filler material 38 may have desired electrical and magnetic characteristics, and be able to withstand the temperature, stress, and abrasive characteristic of a downhole environment. In selected embodiments, the filler material 38 may be surfaced to form to a substantially planer surface 35 of the transmission element 24.

In selected embodiments, the annular housing 28 may include various ridges 40 or other surface characteristics to enable the annular housing 28 to be press fit and retained within an annular recess. These surface characteristics 40 may be produced by stamping, forging, or the like, the surface of the housing 28. In selected embodiments, the annular housing 28 may be formed to retain the MCEI material 34, the conductor 32, any filler material 38, and the like. For example, one or several locking shoulders 36 may be provided or formed in the walls of the annular housing 28. The locking shoulders 36 may allow insertion of the MCEI material 34 into the annular housing 28, while preventing the release therefrom.

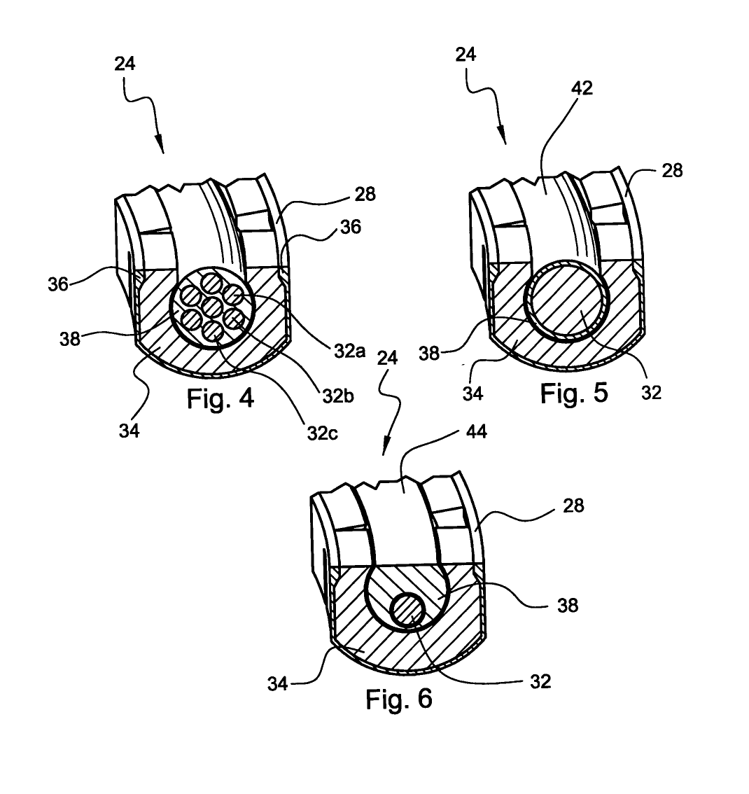

Referring to FIG. 4, in selected embodiments, the electrical conductor 32 may include multiple strands 32a-c, or multiple coils 32a-c, coiled around the circumference of the annular housing 28. In selected embodiments, multiple coils 32a-c may enable or improve the conversion of electrical current to a magnetic field. The coils 32a-c, or loops 32a-c, may be insulated separately or may be encased together by an insulation 38 or filling material 38.

Referring to FIG. 5, in another embodiment, the transmission element 24 may include a single coil 32, or loop 32. The single loop 32 may occupy substantially the entire volume within the MCEI material 34. An insulated conductor 32 may simply provide a rounded surface for interface with another transmission element 24.

Referring to FIG. 6, in another embodiment, the conductor 32 may be much smaller and may or may not be surrounded by a filler material 38. The filler material 38 may be leveled off to provide a planar or substantially flat surface 44 for interfacing with another transmission element 24. In certain cases, a larger electrical conductor 32 may provide better performance with respect to the conversion of electrical energy to magnetic energy, and the conversion of magnetic energy back to electrical energy.

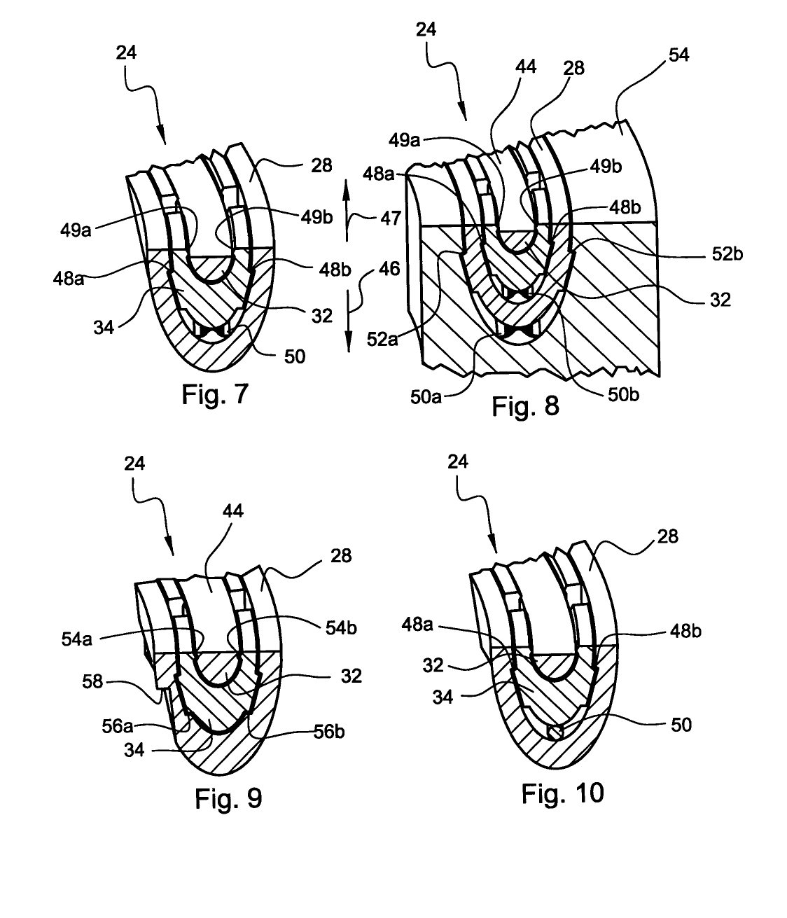

Referring to FIG. 7, in selected embodiments, a transmission element 24 may have a rounded shape. The annular housing 28, the MCEI material 34, and the conductor 32 may be configured to interlock with one another. For example, the annular housing 28 may be formed to include one or more shoulders 48a, 48b that may interlock with and retain the MCEI material 34.

In certain embodiments, a biasing member 50 such as a spring 50 or other spring-like element 50 may function to keep the MCEI material 34 loaded and pressed against the shoulders 48a, 48b of the annular housing 28. The shoulders 48a, 48b may be dimensioned to enable the MCEI material 34 to be inserted into the annular housing 28, while preventing the release thereof. In a similar manner, the conductor 32 may be configured to engage shoulders 49a, 49b formed into the MCEI material 34. In the illustrated embodiment, the conductor 32 has a substantially flat or planar surface 44. This may improve the coupling, or power transfer to another transmission element 24.

Referring to FIG. 8, in another embodiment, locking or retaining shoulders 52a, 52b may be milled, formed, or otherwise provided in a substrate material 54, such as in the primary or secondary shoulders 16, 18, 20, 22 of drill pipes 10 or downhole tools 10. Likewise, corresponding shoulders may be formed in the annular housing 28 to engage the shoulders 52a, 52b.

A biasing member, such as a spring 50a, or spring-like member 50a, may be inserted between the annular housing 28 and the MCEI material 34. The biasing members 50a, 50b may enable the transmission element 24 to be inserted a select distance into the annular recess of the substrate 54. Once inserted, the biasing members 50a, 50b may serve to keep the annular housing 28 and the MCEI material 34 pressed against the shoulders 48a, 48b, 52a, 52b.

In addition, shoulders 48a, 48b, 52a, 52b may provide precise alignment of the annular housing 28, MCEI material 34, and conductor 32 with respect to the surface of the substrate 54. Precise alignment may be desirable to provide consistent separation between transmission elements 24 communicating with one another. Consistent separation between transmission elements 24 may reduce reflections and corresponding power loss when signals are transmitted from one transmission element 24 to another 24.

Referring to FIG. 9, in selected embodiments, a transmission element 24 may include an alignment surface 58 machined, cast, or otherwise provided in the exterior surface of the annular housing 28. The alignment surface 58 may engage a similar surface milled or formed into an annular recess of a substrate 54. This may enable precise alignment of the annular housing 28 and other components 32, 34 with the surface of a substrate 54.

In certain embodiments, the conductor 32 may be provided with grooves 54a, 54b or shoulders 54a, 54b that may engage corresponding shoulders milled or formed into the MCEI material 34. This may enable a surface 44 of the conductor 32 to be level or flush with the surface of the MCEI material 34 and the annular housing 28. In some cases, such a configuration may enable direct physical contact of conductors 32 in the transmission elements 24 when they are coupled together. This may enhance the coupling effect of the transmission elements 24 and enable more efficient transfer of energy therebetween. As is illustrated in FIG. 9, lower shoulders 56a, 56b formed into the annular housing 28 and the MCEI material 34 may provide a substantially fixed relationship between the annular housing 28 and the MCEI material 34.

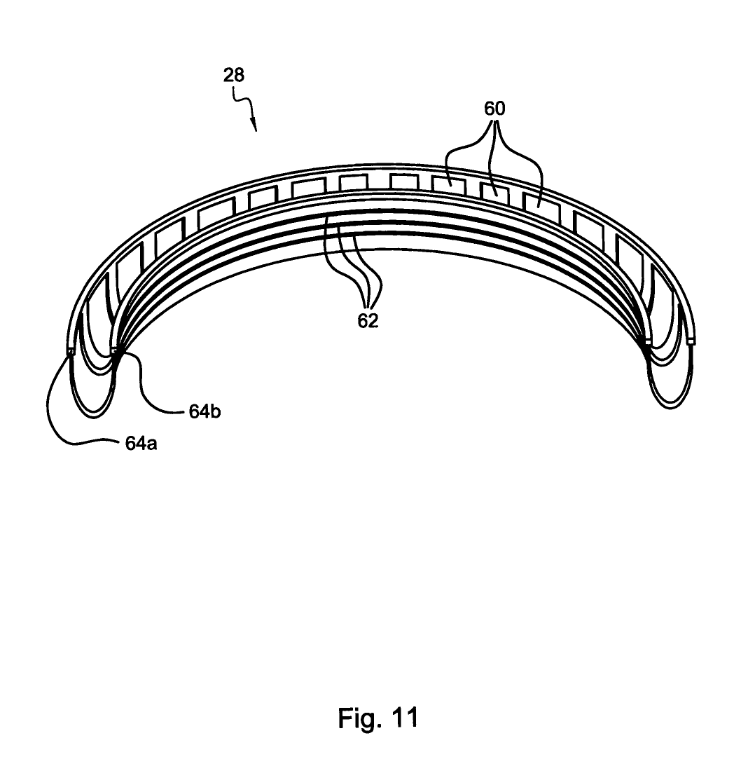

Referring to FIG. 10, in selected embodiments, a biasing member 50 composed of an elastomeric or elastomeric-like material may be inserted between components such as the annular housing 28 and the MCEI material 34. As was previously described with respect to FIG. 7, the biasing member 50 may keep the MCEI material 34 pressed up against shoulders 48a, 48b of the annular housing 28 to provide precise alignment of the MCEI material 34 with the annular housing 28.

Referring to FIG. 11, in selected embodiments, the annular housing 28 may be formed, stamped, milled, or the like, as needed, to maintain alignment or positioning of various components within the annular housing 28. For example, various retention areas 60 may be formed into the annular housing 28 to provide consistent spacing of MCEI segments 34a-c. The retention areas 60 may simply be stamped or hollowed areas within the annular housing 28, or they may be cutout completely from the surface thereof.

Likewise, one or multiple ridges 62 or other surface features 62 may be provided to retain the annular housing 28 in an annular recess when the annular housing 28 is press-fit or inserted into the recess. The annular housing 28 may also include various shoulders 64a, 64b that may engage corresponding shoulders milled or formed into the annular recess to provide precise alignment therewith and to provide a consistent relationship between the surfaces of the transmission element 24 and the substrate 54.

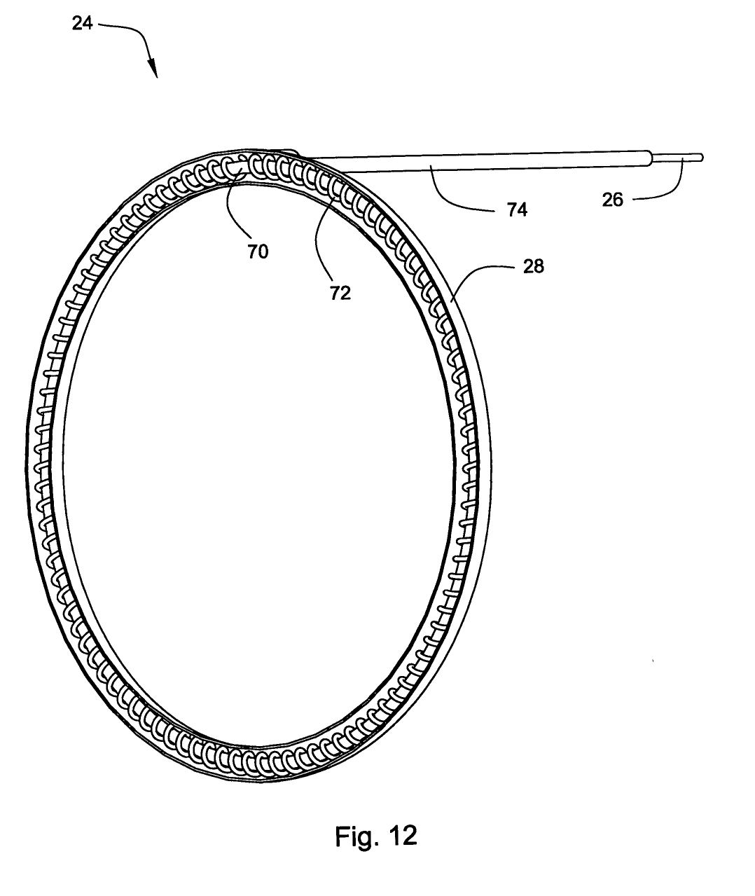

Referring to FIG. 12, in selected embodiments a transmission element 24 may include an electrical conductor 72 coiled around a magnetically conductive annular core 70. One end of the coil 72 may be connected to a conductor 26 or cable 26 for routing along a downhole tool 10. The other end of the conductor 72 may be connected to a return path or ground.

When a voltage is applied across the ends of the coil 72, an electrical begins to flows through the coil 72. The electrical current induces a magnetic field through the center of the coil. This magnetic field may flow through and be substantially retained with the annular core 70. As in the other transmission elements 24 previously described, an annular housing forming an open channel may be used to partially enclose the coil 72 and the annular core 70. Likewise, an insulator 74 may cover a cable 26 or conductor 26 connected to the coil 72.

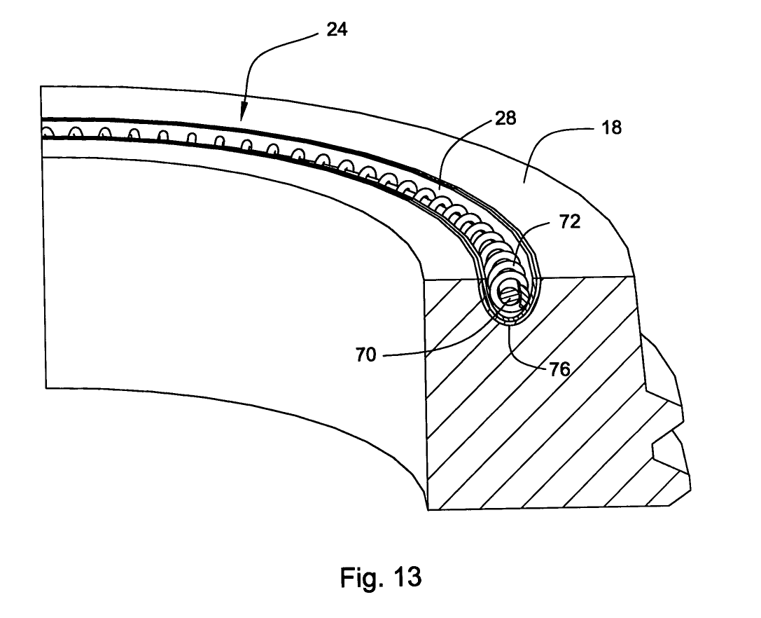

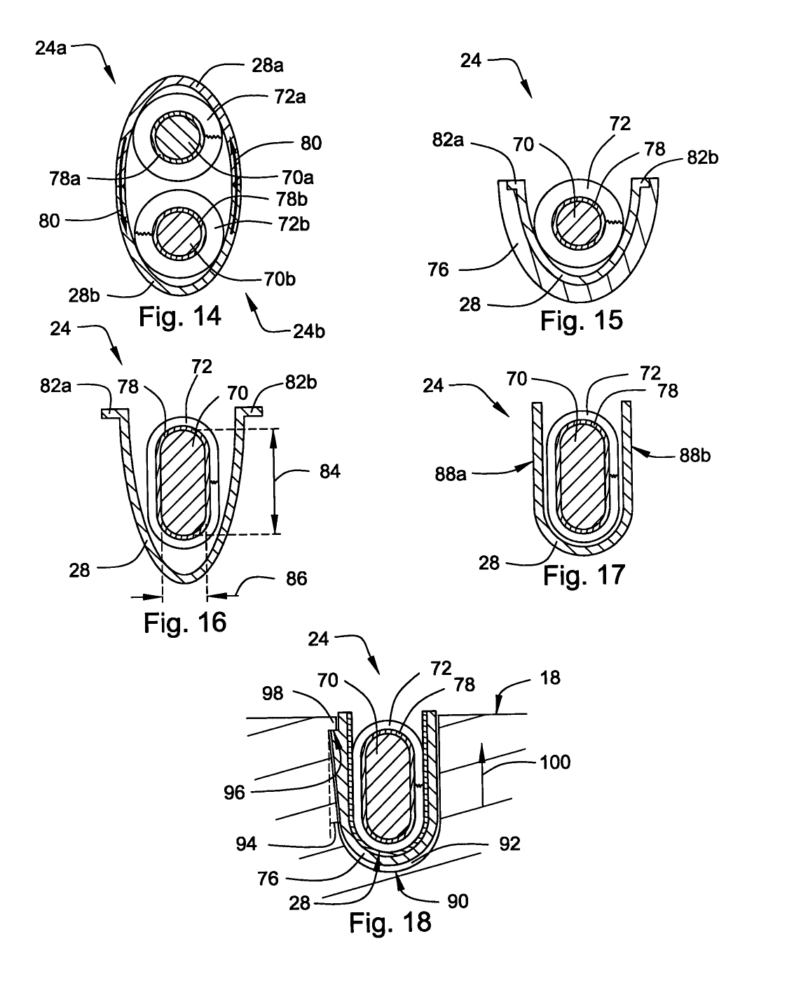

Referring to FIG. 13, for example, a transmission element 24 having a configuration like that described in FIG. 12 may reside within an annular recess formed or milled into a secondary shoulder 18 of a downhole tool 10. As illustrated, the transmission element 24 includes a conductive coil 72 coiled around a magnetically conductive annular core 70. An annular housing 28 may include an exterior insulating layer 76. The insulating layer 76 may serve to isolate or insulate the inner conductive housing 28 from the secondary shoulder 18. The reason for this will be explained in further detail in the description of FIG. 14.

Referring to FIG. 14, a cross-sectional view of a pair of transmission elements 24a, 24b mated together is illustrated. In order to transmit an electrical signal from a first transmission element 24a to another transmission element 24b, an electrical current is transmitted through the conductive coil 72a. This current induces a magnetic field or magnetic flux in the core material 70a that flows in a direction perpendicular to the cross-section 70a, the direction being dependent on the direction current travels through the coil 72a.

When a magnetic field or magnetic flux is induced in the core 70a, the magnetic flux moves through the conductive loop formed by the conductive annular housing 28a and annular housing 28b. A changing magnetic field through this loop 28a, 28b induces an electrical current 80 to travel around the loop 28a, 28b. In turn, this current 80 causes a magnetic flux to travel through the core material 70b perpendicular to the cross-section 70b, the direction depending on the direction electrical current travels through the loop 28a, 28b.

A changing magnetic flux traveling through the core 70b, induces an electrical current in the conductive coil 72b. Thus, electrical current flowing through the coil 72a may induce an electrical current to flow through the coil 72b, thereby providing signal transmission from one transmission element 24a to another 24b. In selected embodiments, the core material 70a, 70b may be coated with an insulator 78a, 78b to prevent electrical contact between the coil 72 and the core 70. In selected embodiments, the coil 72 may be coated with an insulating material to prevent shorting with itself, the annular core 70, and the conductive housing 28.

Referring to FIG. 15, in selected embodiments, a conductive annular housing 28 may include an insulating layer 76 to prevent electrical contact of the annular housing with the recess. In selected embodiments, the annular housing 28 may include flanges 82a, 82b to provide additional contact surface. The flanges 82a, 82b may also function to accurately align the annular housing 28 with the insulating layer 76.

Referring to FIG. 16, in selected embodiments, the conductive coil 72 and annular core 70 may be elongated. Thus, the core 70 and coil 72 may have a relatively narrow width 86 compared to height 84. Since a primary or secondary shoulder of a downhole tool 10 may be quite narrow, this narrow configuration may permit the transmission element 24 to reside within a narrower annular groove formed or milled into the shoulder 18. This may also reduce weakening of the shoulder 18 caused by a wider recess or groove.

In addition, an elongated configuration like that described in FIG. 16 may also improve the power coupling properties of the transmission element 24. This may be due to the increased cross-sectional area of the magnetically conductive core 70. A larger cross-section may cause an increase in the magnetic flux passing therethrough. In certain embodiments, it may be desirable that the height 84 is at least twice the width 86. In selected embodiments, the annular housing 28 may have a rounded contour as illustrated. The advantage of this will be explained in the description of FIG. 18.

Referring to FIG. 17, in other embodiments, the annular housing 28 containing the conductive coil 72 and annular core 70 may have relatively parallel sides 88a, 88b. This may enable the housing 28 to be press fit into an annular recess having sides conforming thereto.

Referring to FIG. 18, in selected embodiments, the annular housing 28 or insulator 76 may be formed to include a shoulder 96 that may interlock with a corresponding shoulder 98 provided in a primary or secondary shoulder of a drill tool 10. The shoulder 96 may enable the housing to slip past the shoulder 98 when inserting the transmission element 24 into the recess 90. However, once interlocked, the transmission element 24 may be retained within the recess 90

In selected embodiments, a wall of the annular housing 28 may form an angle 94 offset with respect to a direction perpendicular to the shoulder surface 18. This angle 94 may urge the transmission element 24 in an upward direction 100, thereby giving the transmission element 24 a bias with respect to the secondary shoulder 18. Designing a transmission element 24 having a radius that is slightly smaller or larger than that of the annular recess 90, into which it is inserted, may produce the bias.

Thus, after the retaining shoulder 96 engages the corresponding shoulder 98 of the secondary shoulder 18, the transmission element 24 may be urged in a direction 100 until the shoulders 96, 98 engage. A top edge of the annular housing 28 and insulator 76 may actually sit above the surface of the secondary shoulder 18. When the transmission element 24 comes into contact with another transmission element 24 located on another tool 10, the transmission element 24 may be urged downward into the recess 90. The upward bias force 100 may maintain reliable connection between the annular housing 28 of the transmission element 24 and a corresponding annular housing 28 located on another transmission element 24, thereby providing reliable electrical contact between the two.

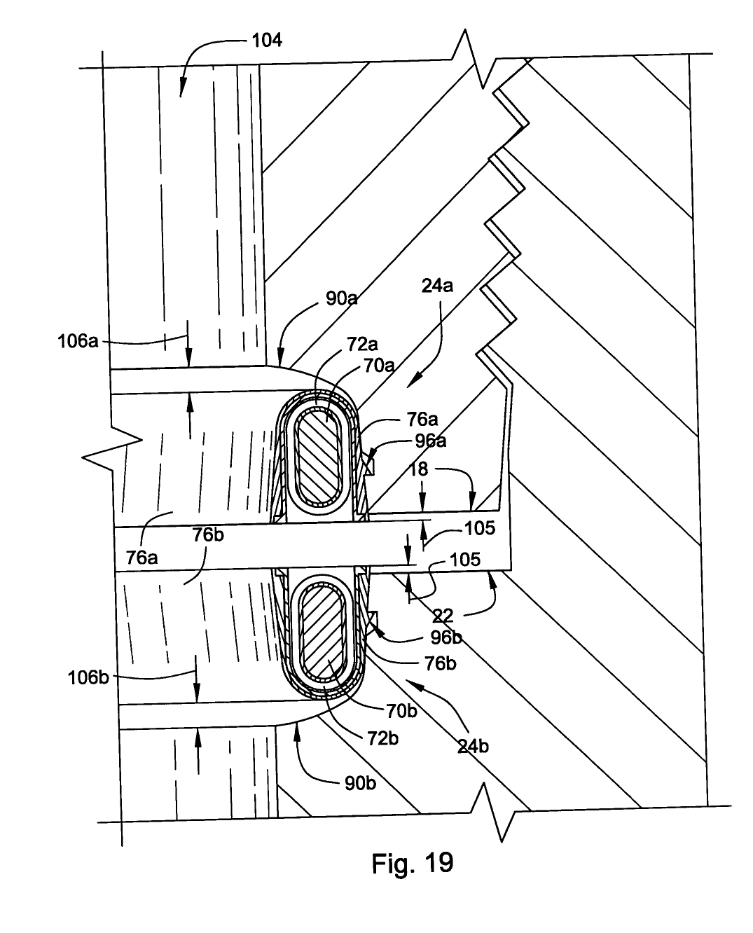

Referring to FIG. 19, for example, in selected embodiments, transmission elements 24a, 24b may be inserted into annular recesses 90a, 90b provided in the secondary shoulders 18, 22 of a pin end and box end of downhole tools 10. In selected embodiments, the recesses 90a, 90b may open up into the central bore 104 of the downhole tool 10. This may reduce the weakening effect that the recesses 90a, 90b might have on the secondary shoulders 18, 22 if they were located closer to the center of the shoulders 18, 22.

As was discussed with respect to FIG. 18, angled sides of the recesses 90a, 90b may provide a spring-force urging the transmission elements 24a, 24b out of their respective recesses 90a, 90b. Because of retention shoulders 96a, 96b, the transmission elements 24a, 24b may be retained within their respective recesses 90a, 90b. Nevertheless, the transmission elements 24a, 24b may sit a select distance 105 from their respective shoulders 18, 22 when not in contact with one another. Thus, gaps 106a, 106b may be present between the transmission elements 24a, 24b and the bottoms of the recesses 90a, 90b, before the transmission elements 24a, 24b contact one another.

As is illustrated, the insulator 76a, 76b used to insulate the transmission elements 24a, 24b electrically from their respective shoulders 18, 22 may actually be exposed to elements within the inside bore 104 of the downhole tools 10. Nevertheless, in other embodiments, recesses 90a, 90b may be provided such that the transmission elements 24a, 24b are completely shielded from the central bore 104.

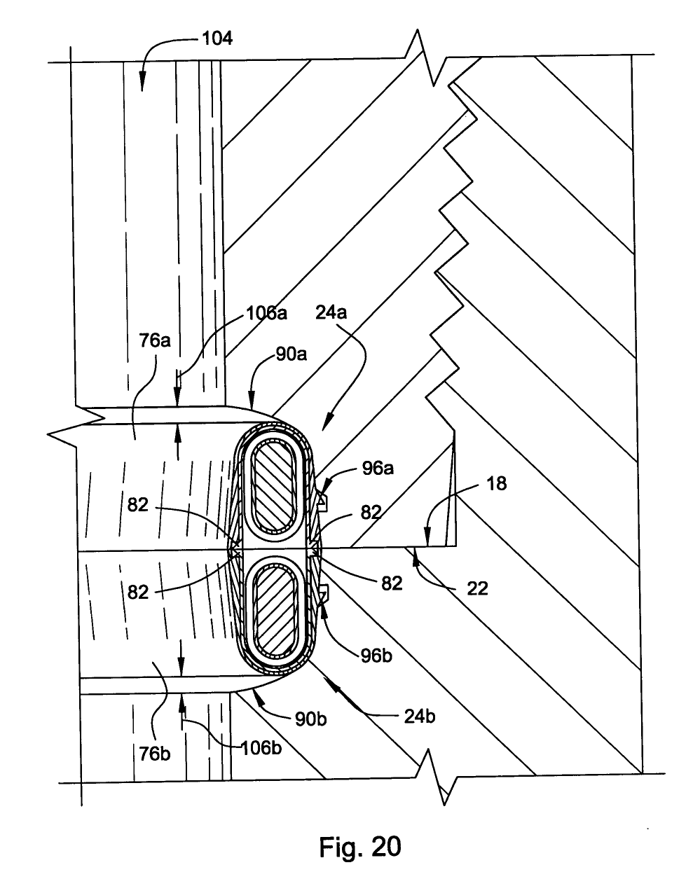

Referring to FIG. 20, when the secondary shoulders 18, 22 come together, transmission elements 24a, 24b may be urged into their respective recesses 90a, 90b. Thus, the gaps 106a, 106b present between transmission elements 24a, 24b and the recesses 90a, 90b may decrease and retention shoulders 96a, 96b may release from corresponding retaining shoulders formed in the recesses 90a, 90b. Since the transmission elements 24a, 24b are spring-loaded with respect to the recesses 90a, 90b, the spring force may keep conductive contact surfaces 82 firmly pressed together, thereby providing a reliable electrical connection between the transmission elements 24a, 24b.

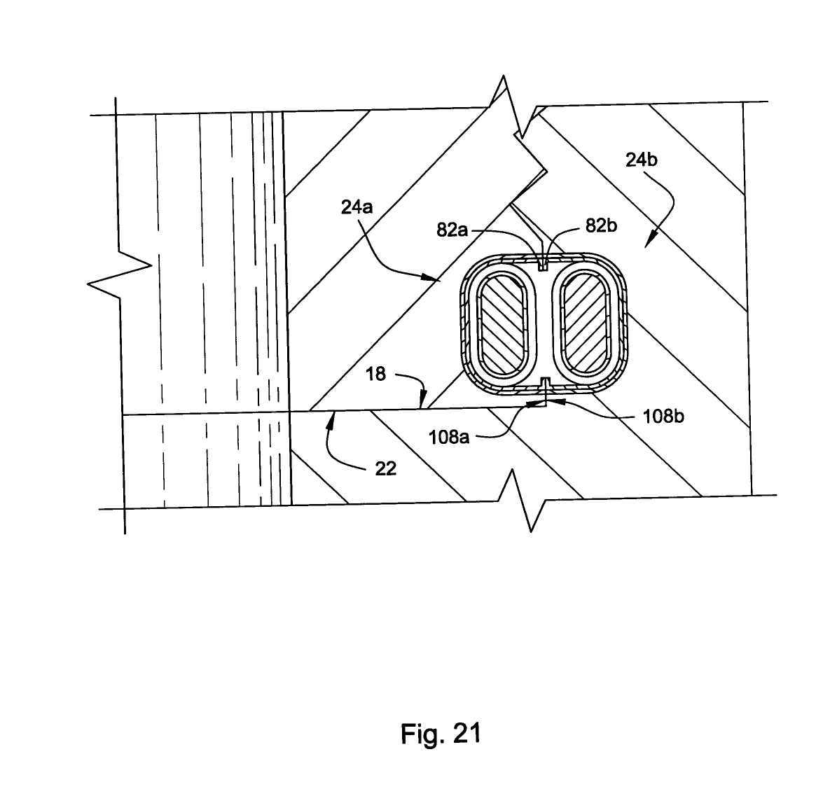

Referring to FIG. 21, in other embodiments, a pair of transmission elements 24a, 24b may reside in recesses formed into longitudinal surfaces 108a, 108b parallel to the central bore 104. Thus, when the secondary shoulders 18, 22 come together, transmission elements 24a, 24b may align with one another and flanges 82a, 82b or contact points 82a, 82b may contact one another to provide an electrical connection. Since the transmission elements 24a, 24b may need to slide past one another when the secondary shoulder 18 approaches the secondary shoulder 22, the transmission elements 24a, 24b may need to sit flush with the surfaces 108a, 108b such that they don't interfere with one another.

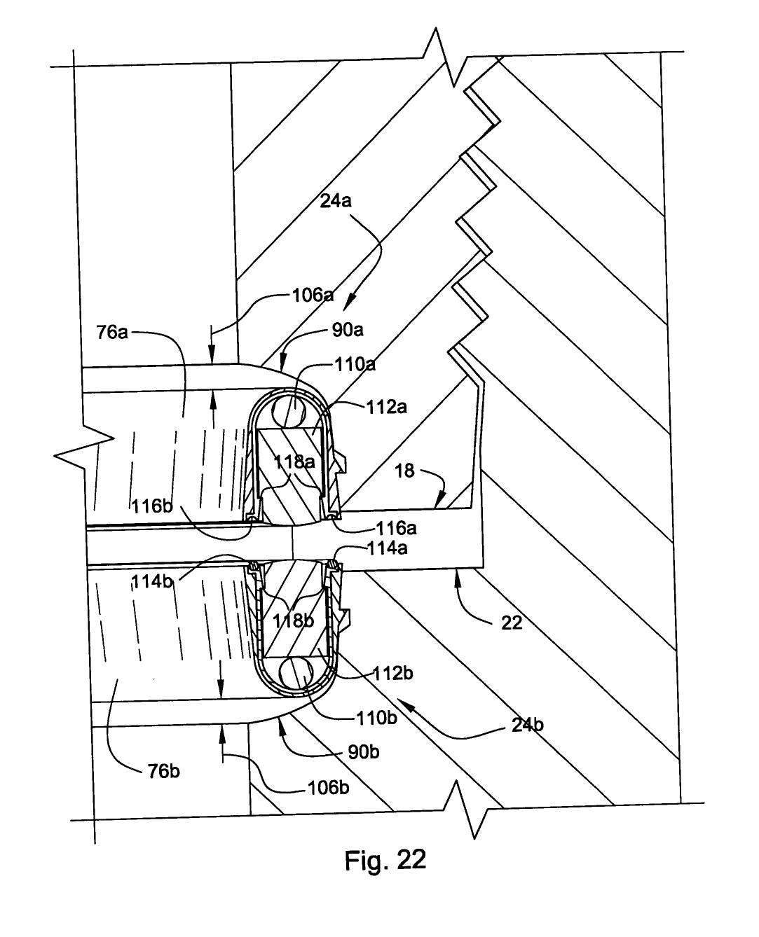

Referring to FIG. 22, in selected embodiments, it may be desirable to directly transmit an electrical signal from one pipe section 10 to another 10 using a direct electrical connection without converting the signal to and from a magnetic field. Since dirt, mud, lubricant, or other materials may interfere with the direct contacts, it may be desirable that the surfaces be self-cleaning. Thus, curved or irregular contact surfaces may be advantageous to push away undesired substances. Moreover, because direct electrical contacts may cause arcing when they are connected or disconnected, it may also be desirable to isolate the electrical contacts such that arcing does not ignite flammable gasses, liquids, or the like, that may be present in a drilling environment.

For example, in one embodiment, transmission elements 24a, 24b having electrical contacts 112a, 112b may be inserted into annular recesses 90a, 90b provided in the secondary shoulders 18, 22 of drill pipes 10 or drill tools 10. In selected embodiments, these transmission elements 24a, 24b may be spring-loaded for the same reasons discussed with respect to FIGS. 19 and 20. Moreover, additional biasing members 110a, 110b constructed of an elastomeric, elastomeric-like, or spring-like material, may be used to provide a bias to the electrical contacts 112a, 112b. This may enable the contacts 112a, 112b to be firmly pressed together to maintain a reliable connection.

To isolate arcing that may occur when electrical contacts 112a, 112b contact one another, seals 114a, 114b that unite with corresponding contact surfaces 116a, 116b may effectively isolate the contacts 112a, 112b, thereby avoiding exposure to explosive or flammable substances.

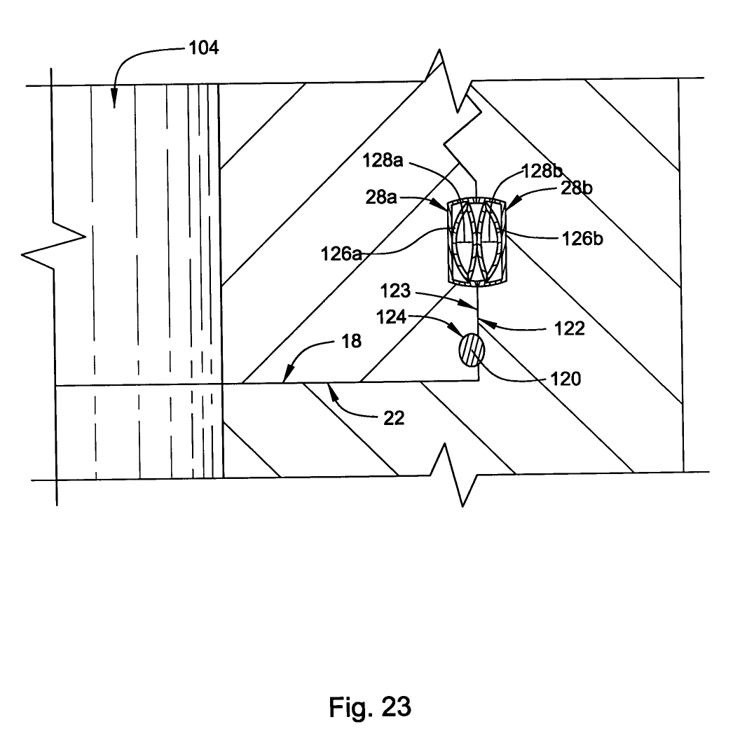

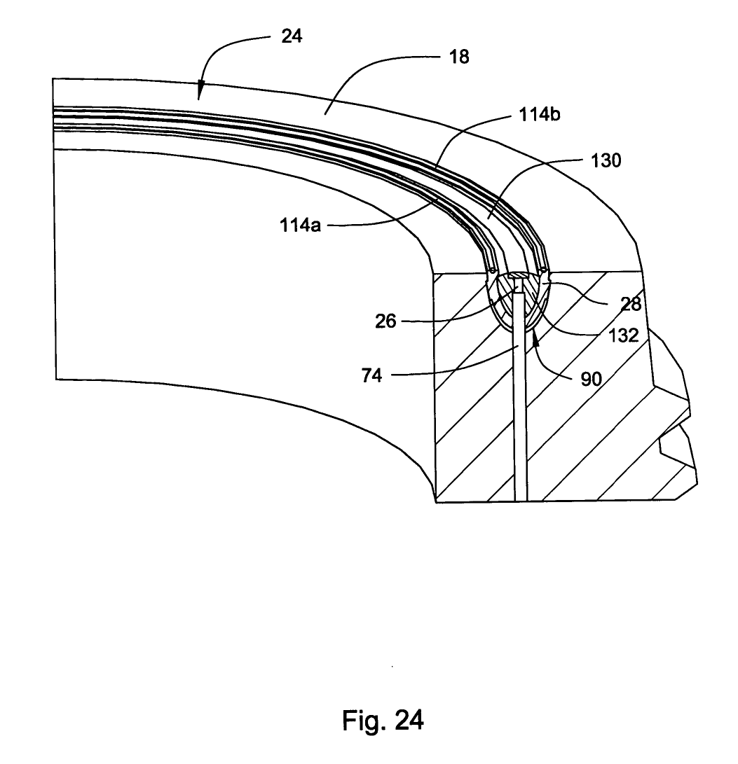

Referring to FIG. 23, in another embodiment, electrical contacts 126a, 126b located in annular housings 28a, 28b, may reside in recesses formed into longitudinal surfaces 122, 123. The contacts 126a, 126b may be elastic or spring-loaded such that they remain effectively pressed together to provide reliable connectivity. For example, the contacts 126a, 126b may compress or expand select distances 128a, 128b. In selected embodiments, to isolate the contacts 126a, 126b from explosive or flammable substances that may be present within a drill string bore 104, a seal 120 may be provided in one of the shoulders 18, 22 to seal with a surface 122. Thus, the contacts 126a, 126b may be effectively isolated from the central bore 104.

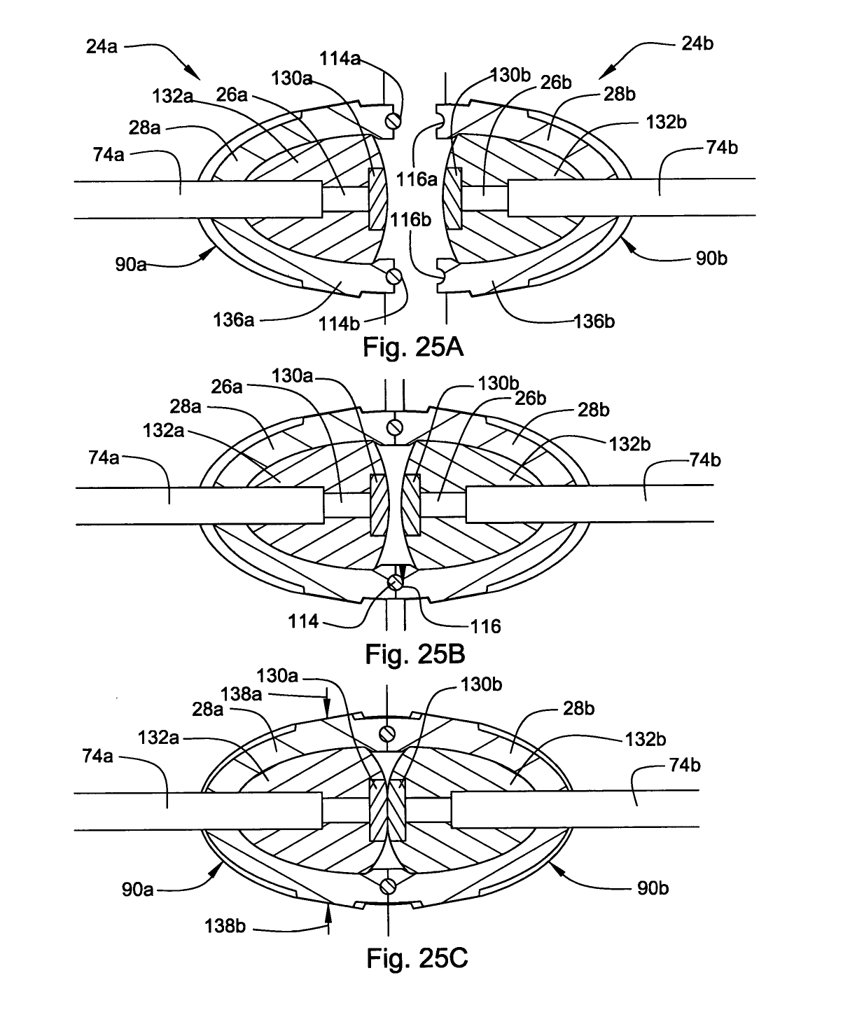

Referring to FIG. 24, a transmission element 24 may include an annular contact 130 around the radius of the transmission element 24. The annular contact 130 may be operably connected to an electrical conductor 26 or other transmission media 26 within an insulator 74. The annular contact 130 may be surrounded by an insulating material 132 that may also have various elastic properties as will be discussed in FIGS. 25A-C.

Likewise, the transmission element 24 may include seals 114a, 114b that may effectively isolate the annular contact from the internal environment of the central bore. The transmission element 24 may include an annular housing 28 that may reside in an annular recess 90 formed or milled into the secondary shoulder 18. As has been discussed previously, the annular housing 28 may interlock with shoulders or other retention mechanisms provided within the annular recess 90. Moreover, angled surfaces of the annular housing 28 and recess 90 may provide a biasing effect to urge the transmission element 24 into a position slightly above the surface of the secondary shoulder 18.

Referring to FIGS. 25A-C, various positions of transmission elements 24a, 24b are illustrated. As was previously mentioned, transmission elements 24a, 24b may use electrical contacts 130a, 130b to directly transmit an electrical signal therebetween. The electrical contacts 130a, 130 may be connected to electrical conductors 26a, 26b for transmission along the drill string. The electrical contacts 130a, 130b may be surrounded by an elastic insulating material 132a, 132b to provide electrical isolation from the annular housings 28a, 28b, which may be constructed of an electrically conductive material.

The annular housings 28a, 28b may include various shoulders 136a, 136b that may interlock with corresponding shoulders in the recesses 90a, 90b. Likewise, the annular housings 28a, 28b may include seals 114a, 114b that may mate with seal contact surfaces 116a, 116b before the electrical contacts 130a, 130b meet. With respect to FIG. 25B, when the seals 114 and corresponding surfaces 116 meet, the electrical contacts 130a, 130b may still be separated.

Referring to FIG. 25C, when the secondary shoulders 18, 22 come together, the annular housings 28a, 28b may be urged into their corresponding recesses 90a, 90b. Since the sides of the recesses 90a, 90b may be angled, this may exert side pressure 138a, 138b on the annular housings 28a, 28b. This pressure 138a, 138b may flex the annular housings 28a, 28b and cause compression of the elastic insulating material 132a, 132b. This may urge the electrical contacts 130a, 130b to contact one another. Moreover, since the material 132a, 132b is elastic, the annular housings 28a, 28b may actually shift in position with respect to the electrical contacts 130a, 130b, thereby allowing them to make contact.

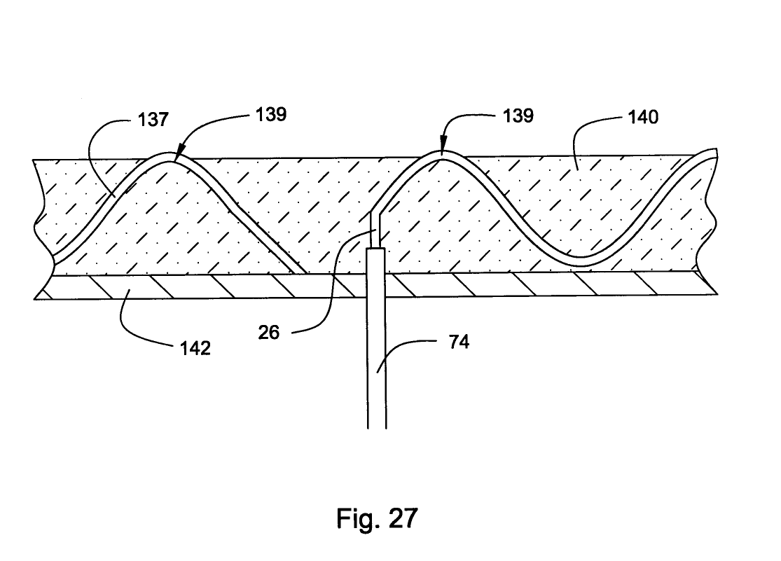

Referring to FIGS. 28A-C, in another embodiment, a rounded or curved contact 130b may be configured to contact a relatively flat electrical contact 130a. As in the example illustrated in FIGS. 27A-C, the contacts 130a, 130b may be surrounded by an elastic insulating material 132a, 132b. The elastic material 132a, 132b may include various contact points 138a, 138b that may contact one another before contact of the electrical contacts 130a, 130b. Thus, the electrical contacts 130a, 130b may be effectively isolated from their surrounding environment, preventing arcing or ignition of explosive or flammable substances that may be present in a downhole-drilling environment.

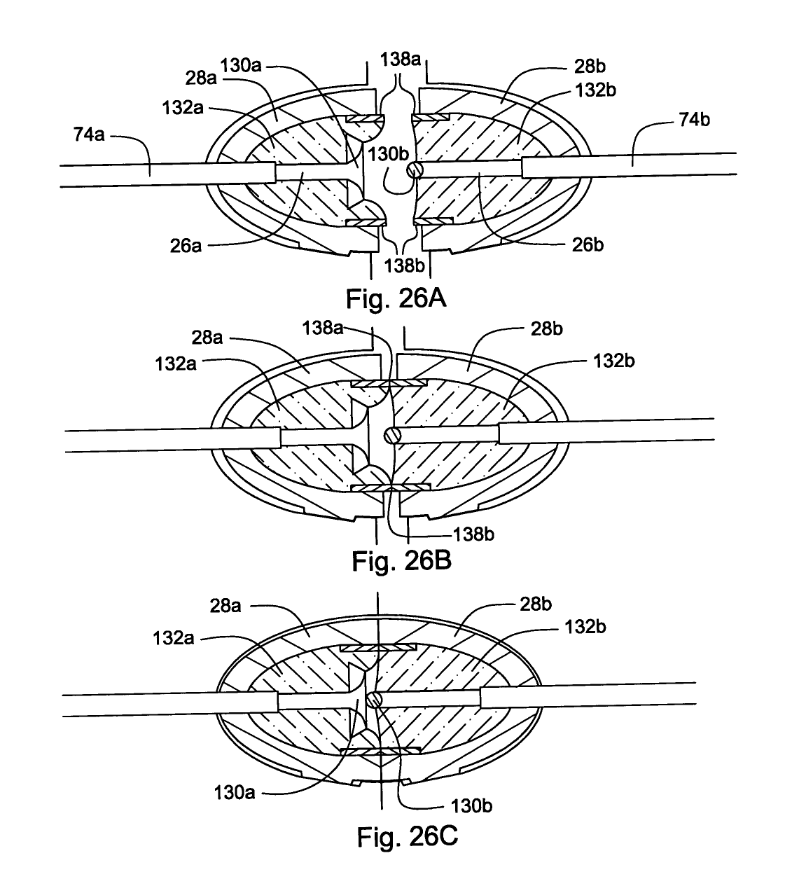

As illustrated by FIG. 26B, as the annular housings 28a, 28b come together, the elastic insulating materials 132a, 132b meet at contact points 138a, 138b before contact of electrical contacts 130a, 130b. As illustrated by FIG. 26C, as the secondary shoulders 18, 22 continue to come together, the annular housings 28a, 28b are likewise brought together. This compresses the elastic insulating materials 132a, 132b further urging the contacts 130a, 130b into contact with one another.

Referring to FIG. 27, one example of an electrical contact 130 is illustrated. In certain embodiments, an electrical contact 130 may include a conductor 137 having peaks 130. These peaks 139 may create an irregular surface which may improve reliable contact by pushing away dirt, fluids, or other substances that might interfere with the contact 130. In selected embodiments, the conductor 137 may be contained in a surrounding material 140 which may or may not be electrically conductive. The contact 130 may be connected to a conductor 26 that may be routed along a drill string. This conductor 36 may be coated by a insulating material 74.

The present invention may be embodied in other specific forms without departing from its essence or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be embraced within their scope.

1. A transmission element for transmitting information between downhole tools located on a drill string, the transmission element comprising:
an annular core constructed of a magnetically-conductive material;
at least one conductor coiled around the annular core and electrically isolated therefrom;
an annular housing constructed of an electrically conductive material and partially enclosing the annular core and the at least one conductor;
the annular housing further shaped to reside with an annular recess formed into a surface of a downhole tool, and being electrically insulated from the surface thereof;
a biasing member to effect a bias between the annular housing and the annular recess, urging the annular housing in a direction substantially perpendicular to the surface.

2. The transmission element of claim 1, further comprising a retention mechanism for retaining the annular housing within an annular recess.

3. The transmission element of claim 1, wherein the at least one conductor is coated with an electrically insulating material.

4. The transmission element of claim 1, wherein the surface is selected from the group consisting of a secondary shoulder of a pin end, a secondary shoulder of a box end, a primary shoulder of a pin end, and a primary shoulder of a box end of a downhole tool.

5. The transmission element of claim 1, wherein the annular housing is at least partially exposed to the central bore of a downhole tool;

6. The transmission element of claim 1, wherein the biasing member is selected from the group consisting of a metal spring, an elastomeric material, and an elastomeric-like material.

7. The transmission element of claim 1, wherein the annular core is characterized by an elongate cross-section.

8. The transmission element of claim 1, wherein the annular core has a cross-section characterized by a height at least twice that of its width.

9. The transmission element of claim 1, wherein the annular housing further comprises a shoulder formed along the exterior thereof, configured to engage a corresponding shoulder formed within an annular recess.

10. The transmission element of claim 1, wherein the annular housing is configured to make electrical contact with a second annular housing located on a second transmission element, and wherein the contact surfaces of each annular housing are formed to be self-cleaning.

11. A transmission element for transmitting information between downhole tools located on a drill string, the transmission element comprising:
an annular core constructed of a magnetically-conductive material;
at least one conductor coiled around the annular core and electrically isolated therefrom;
an annular housing constructed of an electrically conductive material and partially enclosing the annular core and the at least one conductor;
the annular housing further shaped to reside with an annular recess formed into a surface of a downhole tool, and being electrically insulated from the surface thereof;
means for effecting a bias between the annular housing and the annular recess;

12. The transmission element of claim 11, wherein the means for effecting a bias between the annular housing and the annular recess is due to radial tension between surfaces of the annular housing and an annular recess.

13. The transmission element of claim 12, wherein the radial tension between the surfaces of the annular housing and the annular recess are due to tension along at least one of the outside diameters, the inside diameters, and a combination thereof, of the annular housing and annular recess.

14. The transmission element of claim 11, further comprising a retention mechanism for retaining the annular housing within an annular recess.

15. The transmission element of claim 11, wherein the annular housing is at least partially exposed to the central bore of a downhole tool;

16. An apparatus for transmitting information between downhole tools located on a drill string, the apparatus comprising:
a first transmission element, mounted to the end of a first downhole tool, the first transmission element comprising a first contact;
a second transmission element, mounted to the end of a second downhole tool connectable to the first downhole tool, the second transmission element comprising a second contact configured to physically contact the first contact upon connecting the first and second downhole tools; and
an isolation mechanism configured to isolate the first and second contacts from an adjacent environment when contact occurs between the first and second contacts.

17. The apparatus of claim 16, wherein the isolation mechanism further comprises:
a first isolation component connected to the first transmission element; and
a second isolation component connected to the second transmission element, the second isolation mechanism configured to engage the first isolation mechanism upon connecting the first and second downhole tools.

18. The apparatus of claim 17, wherein the first and second isolation components are annular housings having substantially U-shaped cross-sections and are formed to reside within annular recesses formed in the first and second downhole tools, respectively.

19. The apparatus of claim 18, wherein the first and second contacts are conductive rings formed to reside within the first and second annular housings, respectively.

20. The apparatus of claim 19, wherein the conductive rings are electrically insulated from the first and second annular housings, respectively.

21. The apparatus of claim 19, wherein the conductive rings are coupled to the first and second annular housings, respectively, by a at least one of a resilient, an elastomeric, and an elastomeric-like material.
